(19) United States
(12) Patent Application Publication
(10) Pub. No.: US 2019/0341845 A1
(43) Pub. Date: Nov. 7, 2019

(54) STEP-UP CONVERTER

(71) Applicant: SILICON WORKS CO., LTD., Daejeon (KR)

(72) Inventor: Young Jin WOO, Daejeon (KR)

(21) Appl. No.: 16/393,657

(22) Filed: Apr. 24, 2019

(30) Foreign Application Priority Data
May 4, 2018 (KR) 10-2018-0051634

(51) Int. Cl. H02M 3/07; H02M 1/08

(52) U.S. Cl. CPC H02M 3/07; H02M 1/08

(57) ABSTRACT

An embodiment provides a technology of controlling, in a step-up converter using a flying capacitor, a charging/discharging balance of the flying capacitor by connecting an auxiliary capacitor in parallel to the flying capacitor in one time interval and connecting the auxiliary capacitor to the flying capacitor in series in another time interval, in each control period.

### CROSS REFERENCE TO RELATED APPLICATION

This application claims priority from Republic of Korea Patent Application No. 10-2018-0051634, filed on May 4, 2018, which is hereby incorporated by reference for all purposes as if fully set forth herein.

### BACKGROUND

### 1. Field of the invention

The present disclosure relates to a converter that converts power.

### 2. Description of the Prior Art

Among converters that convert power, a converter that increases an output voltage to be higher than an input voltage and outputs the increased output voltage is referred to as a step-up converter. In some cases, a step-up converter is also referred to as a boost converter.

In general, a step-up converter has a structure of building up current in an inductor in one time interval corresponding to DT (D is a duty cycle, and T is a switching period) and outputting the built-up current to a load in another time interval corresponding to (1-D)T. In practical implementations, because an inductor current cannot be supplied directly to a load, an output capacitor is inserted between the inductor and the load, and the inductor current is supplied to the load via the output capacitor.

A flying capacitor may be included in the step-up converter to change a voltage ratio of an input voltage and an output voltage. The step-up converter may increase or decrease the voltage ratio while charging or discharging the flying capacitor in each control period.

However, a conventional step-up converter including a flying capacitor has technical difficulties in maintaining the charging/discharging balance of the flying capacitor. There is a problem in that an output voltage is abnormally generated if the charging/discharging balance of the flying capacitor is not maintained. In order to solve this problem, the conventional step-up converter receives feedback on the voltage of the flying capacity to perform control, but such a method has problems of a complicated control logic and an additional cost due to the necessity of controlling both an output voltage and a flying capacity voltage.

### SUMMARY

Based on this background, an aspect of the present embodiment is to provide a step-up converter technology that enables easy control of the charging/discharging balance of a flying capacitor.

In view of the foregoing, an embodiment provides a step-up converter including an inductor unit, a power switch unit, an auxiliary capacitor, and a control unit.

The inductor unit may receive an input voltage in one side thereof, and may include at least one inductor.

The power switch unit may include at least four serially connected power switches to control power path and at least one flying capacitor connected in parallel to at least two power switches among the at least four power switches, and one node between the at least two power switches may be connected to the other side of the inductor unit.

The auxiliary capacitor may be connected to the one node via an auxiliary switch.

The control unit may control the power switch unit to convert the input voltage into an output voltage, may connect the at least one flying capacitor and the auxiliary capacitor in parallel in one time interval, and may connect the at least one flying capacitor and the auxiliary capacitor in serial in another time interval, in each control period.

The control unit may control the power switch unit so that voltage of the one node changes four times or more in each control period.

The at least one flying capacitor may be charged in the one time interval, and the at least one flying capacitor may be discharged in the another time interval.

The at least one flying capacitor and the auxiliary capacitor may be connected in parallel to an output capacitor in which the output voltage is generated in the another time interval.

A ground voltage and the output voltage may be generated at both ends of the power switch unit, and flying capacitor voltage may be generated in the at least one flying capacitor. The control unit may control the power switch unit to generate the ground voltage in the one node in a first time interval, generate voltage of a level obtained by adding the flying capacitor voltage to the ground voltage in the one node in a second time interval, generate the ground voltage in the one node in a third time interval, and generate voltage of a level obtained by subtracting the flying capacitor voltage from the output voltage in the one node in a fourth time interval.

The control unit may turn off the auxiliary switch in the first time interval and the third time interval, and may turn on the auxiliary switch in the second time interval and the fourth time interval, so as to connect the auxiliary capacitor to the one node.

The ground voltage and the output voltage may be generated at both ends of the power switch unit, and the flying capacitor voltage may be generated in the at least one flying capacitor. The control unit may control the power switch unit to generate voltage obtained by adding the flying capacitor voltage to the ground voltage in the one node in the first time interval, and generate the output voltage in the one node in the second time interval, generate voltage of a level obtained by subtracting the flying capacitor voltage from the output voltage in the one node in the third time interval, and generate the output voltage in the one node in the fourth time interval.

The control unit may turn on the auxiliary switch in the first time interval and the third time interval so as to connect the auxiliary capacitor to the one node, and may turn off the auxiliary switch in the second time interval and the fourth time interval.

Another embodiment provides a step-up converter including an inductor unit, a power switch unit, an auxiliary capacitor, and a control unit.

The inductor unit may receive an input voltage in one side thereof, and may include at least one inductor.

The power switch unit may include at least four serially connected power switches to control power path and at least one flying capacitor connected in parallel to at least two power switches among the at least four power switches, and one node between the at least two power switches may be connected to the other side of the inductor unit.

The auxiliary capacitor may be connected to the at least one flying capacitor via two auxiliary switches connected to both ends of the at least one flying capacitor, respectively.

The control unit may control the power switch unit to convert the input voltage into an output voltage, may connect the at least one flying capacitor and the auxiliary capacitor in parallel in one time interval, and may connect the at least one flying capacitor and the auxiliary capacitor in serial in another time interval, in each control period.

The control unit may control the power switch unit so that voltage of the one node changes four times or more in each control period.

The at least one flying capacitor and the auxiliary capacitor may be connected in parallel to an output capacitor in which the output voltage is generated in the another time interval.

The ground voltage and the output voltage may be generated at both ends of the power switch unit, and the flying capacitor voltage may be generated in the at least one flying capacitor. The control unit may control the power switch unit to generate the ground voltage in the one node in a first time interval, generate voltage of a level obtained by adding the flying capacitor voltage to the ground voltage in the one node in a second time interval, generate the ground voltage in the one node in a third time interval, and generate voltage of a level obtained by subtracting the flying capacitor voltage from the output voltage in the one node in a fourth time interval.

The control unit may: turn off a first auxiliary switch and a second auxiliary switch in the first time interval and the third time interval; turn on the first auxiliary switch connected to the positive terminal of the at least one flying capacitor and turn off the second auxiliary switch so as to connect the auxiliary capacitor to the positive terminal of the at least one flying capacitor, in the second time interval; and turn on the second auxiliary switch connected to the negative terminal of the at least one flying capacitor and turn off the first auxiliary switch so as to connect the auxiliary capacitor to the negative terminal of the at least one flying capacitor, in the fourth time interval.

The ground voltage and the output voltage may be generated at both ends of the power switch unit, and the flying capacitor voltage may be generated in the at least one flying capacitor. The control unit may control the power switch unit to generate voltage obtained by adding the flying capacitor voltage to the ground voltage in the one node in the first time interval, and generate the output voltage in the one node in the second time interval, generate voltage of a level obtained by subtracting the flying capacitor voltage from the output voltage in the one node in the third time interval, and generate the output voltage in the one node in the fourth time interval.

The control unit may: turn off the first auxiliary switch and the second auxiliary switch in the second time interval and the fourth time interval; turn on the first auxiliary switch connected to the positive terminal of the at least one flying capacitor and turn off the second auxiliary switch so as to connect the auxiliary capacitor to the positive terminal of the at least one flying capacitor, in the first time interval; and turn on the second auxiliary switch connected to the negative terminal of the at least one flying capacitor and turn off the first auxiliary switch so as to connect the auxiliary capacitor to the negative terminal of the at least one flying capacitor, in the third time interval.

As described above, according to the embodiments, the charging/discharging balance of flying capacitors used in the step-up converter can be easily controlled.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a state diagram illustrating a first time interval of a general multilevel step-up converter;

FIG. 2 is a state diagram illustrating a second time interval of the general multilevel step-up converter;

FIG. 3 is a state diagram illustrating a third time interval of the general multilevel step-up converter;

FIG. 4 is a state diagram illustrating a fourth time interval of the general multilevel step-up converter;

FIG. 5 is a waveform diagram for voltage of a flying capacitor in the general multilevel step-up converter;

FIG. 6 is a configuration diagram of a step-up converter to which embodiments can be applied.

FIG. 7 is a first exemplary configuration diagram illustrating a power stage of a step-up converter according to an embodiment.

FIG. 8 is a second exemplary configuration diagram illustrating a power stage of a step-up converter according to an embodiment.

FIG. 9 is a first time interval state diagram illustrating a time at which the power stage according to a second example of an embodiment is controlled by a first control method;

FIG. 10 is a second time interval state diagram illustrating the time at which the power stage according to the second example of the embodiment is controlled by the first control method;

FIG. 11 is a third time interval state diagram illustrating the time at which the power stage according to the second example of the embodiment is controlled by the first control method;

FIG. 12 is a fourth time interval state diagram illustrating the time at which the power stage according to the second example of the embodiment is controlled by the first control method;

FIG. 13 is a first time interval state diagram illustrating a time at which the power stage according to the second example of the embodiment is controlled by a second control method;

FIG. 14 is a second time interval state diagram illustrating the time at which the power stage according to the second example of the embodiment is controlled by the second control method;

FIG. 15 is a third time interval state diagram illustrating the time at which the power stage according to the second example of the embodiment is controlled by the second control method;

FIG. 16 is a fourth time interval state diagram illustrating the time at which the power stage according to the second example of the embodiment is controlled by the second control method;

FIG. 17 is a first exemplary configuration diagram illustrating a power stage of a step-up converter according to another embodiment;

FIG. 18 is a second exemplary configuration diagram illustrating a power stage of a step-up converter according to another embodiment;

FIG. 19 is a first time interval state diagram illustrating a time at which the power stage according to a second example of another embodiment is controlled by a first control method;

FIG. 20 is a second time interval state diagram illustrating the time at which the power stage according to the second example of another embodiment is controlled by the first control method;

FIG. 21 is a third time interval state diagram illustrating the time at which the power stage according to the second example of another embodiment is controlled by the first control method;

FIG. 22 is a fourth time interval state diagram illustrating the time at which the power stage according to a second example of another embodiment is controlled by the first control method;

FIG. 23 is a first time interval state diagram illustrating the time at which the power stage according to the second example of another embodiment is controlled by the second control method;

FIG. 24 is a second time interval state diagram illustrating the time at which the power stage according to a second example of another embodiment is controlled by a second control method;

FIG. 25 is a third time interval state diagram illustrating the time at which the power stage according to the second example of another embodiment is controlled by the second control method; and

FIG. 26 is a fourth time interval state diagram illustrating the time at which the power stage according to the second example of another embodiment is controlled by the second control method.

### DETAILED DESCRIPTION

Hereinafter, embodiments of the present disclosure will be described in detail with reference to the accompanying drawings. In adding reference numerals to elements in each drawing, the same elements will be designated by the same reference numerals as far as possible, although they are shown in different drawings. Further, in the following description of the present disclosure, a detailed description of known functions and configurations incorporated herein will be omitted when it is determined that the description may make the subject matter of the present disclosure rather unclear.

In addition, terms, such as first, second, A, B, (a), (b) or the like may be used herein when describing components of the present disclosure. These terms are merely used to distinguish one structural element from other structural elements, and a property, an order, a sequence or the like of a corresponding structural element are not limited by the term. When it is described in the specification that one component is “connected,” “coupled” or “joined” to another component, it should be read that the first component may be directly connected, coupled or joined to the second component, but also a third component may be “connected,” “coupled,” and “joined” between the first and second components.

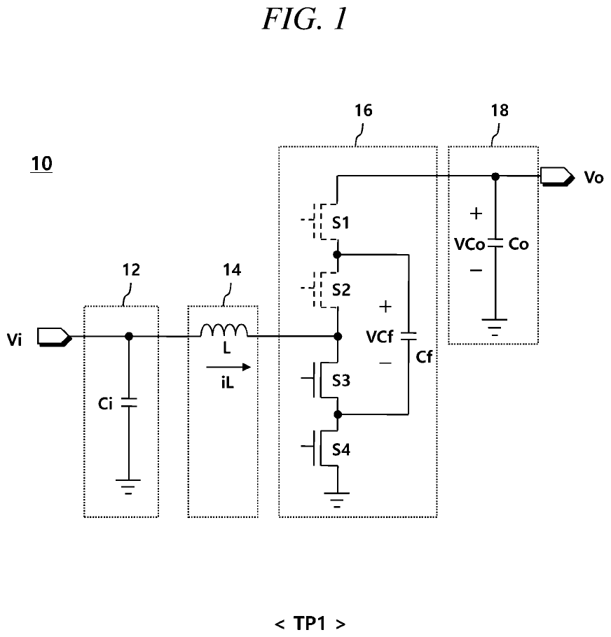

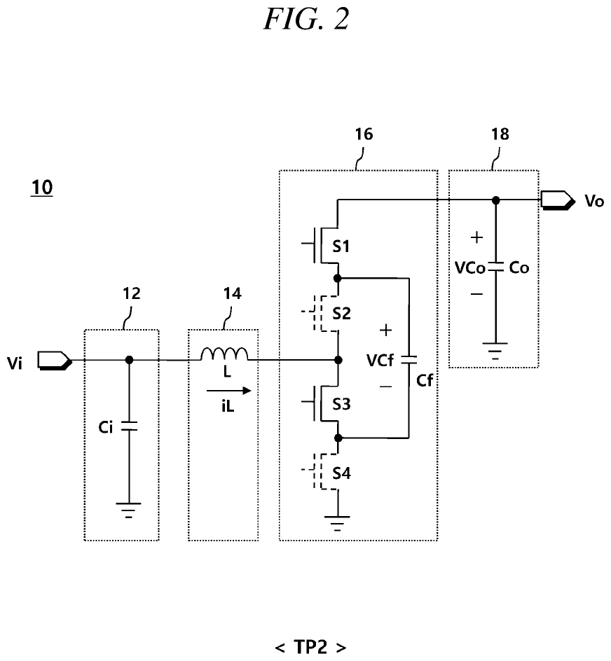

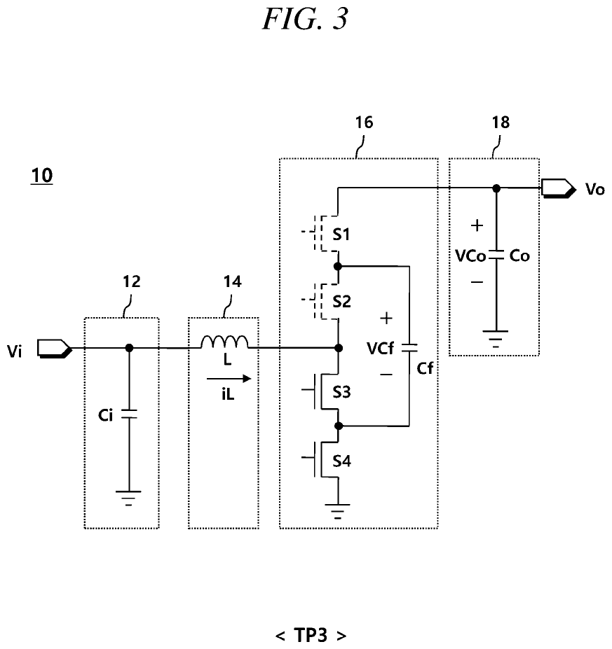

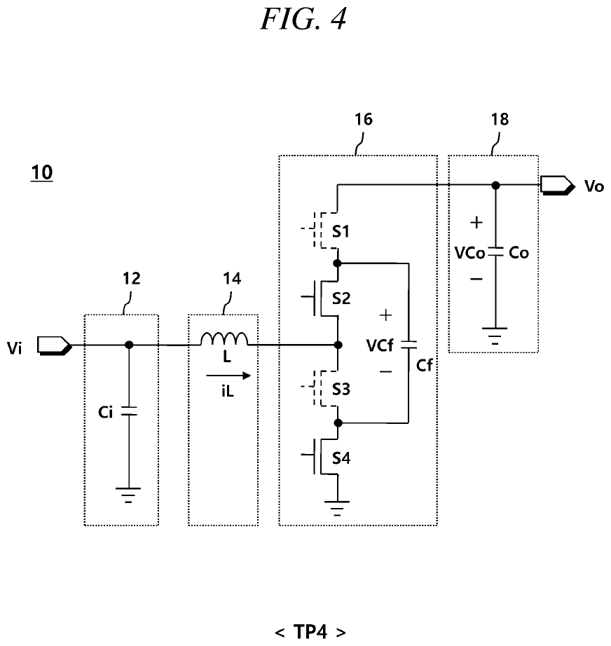

FIG. 1 is a state diagram illustrating a first time interval of a general multilevel step-up converter, and FIG. 2 is a state diagram of a second time interval of the general multilevel step-up converter. FIG. 3 is a state diagram illustrating a third time interval of the general multilevel step-up converter, and FIG. 4 is a state diagram of a fourth time interval of the general multilevel step-up converter.

Referring to FIG. 1 to FIG. 4, the general multilevel step-up converter 10 includes an input unit 12, an inductor unit 14, a switch unit 16, and an output unit 18.

The input unit 12 includes an input capacitor Ci that receives an input voltage (Vi).

The inductor unit 14 includes an inductor L, wherein one side of the inductor L is connected to the input capacitor Ci, and the other side of the inductor L is connected to the switch unit 16.

The switch unit 16 includes four switches S1, S2, S3, and S4, and a flying capacitor Cf, wherein a node connected to the second switch S2 and the third switch S3 is connected to the other side of the inductor (L), and both ends of the flying capacitor Cf are connected to a node between the first switch S1 and the second switch S2 and a node between the third switch S3 and the fourth switch S4, respectively.

The output unit 18 includes an output capacitor Co, and the output capacitor Co is connected to the first switch S1.

The multilevel step-up converter 10 turns on the third switch S3 and the fourth switch S4 in a first time interval (TP1) of a control period, so as to build up current (iL) in the inductor L. The multilevel step-up converter 10 turns on the first switch S1 and the third switch S3 in a second time interval (TP2), so as to transfer the current (iL) of the inductor L to the output capacitor Co via the flying capacitor Cf.

The multilevel step-up converter 10 turns on the third switch S3 and the fourth switch S4 in a third time interval (TP3) of the control period, so as to build up the current (iL) in the inductor L. The multilevel step-up converter 10 turns on the second switch S2 and the fourth switch S4 in a fourth time interval (TP4), so as to transfer the current (iL) of the inductor L to the ground via the flying capacitor Cf.

For the general multilevel step-up converter 10, the flying capacitor Cf is discharged in the second time interval (TP2) of the control period, and the flying capacitor Cf is charged in the fourth time interval (TP4). However, at this time, if a charging amount and a discharging amount of the flying capacitor Cf do not match, voltage of the flying capacitor Cf in each control period is generated differently so that a problem in that control or an output voltage (Vo) becomes unstable occurs.

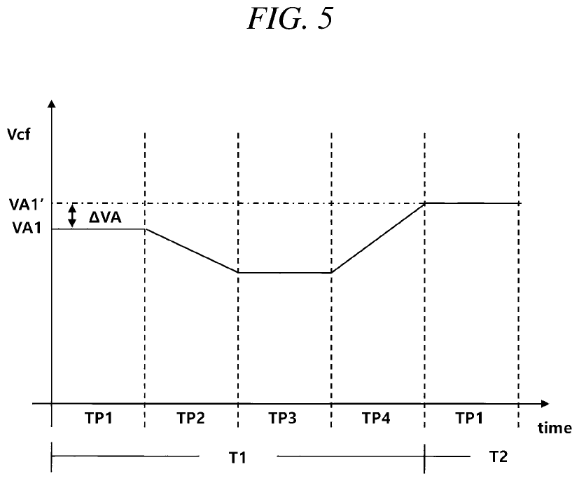

FIG. 5 is a waveform diagram for voltage of a flying capacitor in the general multilevel step-up converter.

Referring to FIG. 1 to FIG. 5, because the flying capacitor Cf floats in the first time interval (TP1), a constant voltage (VA) is maintained. As the flying capacitor Cf is discharged by the inductor current (iL) in the second time interval (TP2), voltage (Vcf) thereof becomes smaller.

The flying capacitor Cf is floated again in the third time interval (TP3) and thus voltage determined at a last moment of the second time interval (TP2) is maintained. The flying capacitor Cf is charged by the inductor current (iL) in the fourth time interval (TP4), and the the voltage (Vcf) thereof becomes large.

In this procedure, if a mismatch occurs between a discharging amount in the second time interval (TP2) and a charging amount in the fourth time interval (TP4), there occurs, as illustrated in FIG. 5, a problem in that a voltage difference (ΔVA) is generated between voltage (VA) in the first time interval (TP1) of a first control period (T1) and voltage (VA′) in the first time interval (TP1) of a second control period (T2), in the voltage (Vcf) of the flying capacitor.

If voltage of a flying capacitor is generated differently in each control period, a control or an output voltage may be unstable. However, the step-up converter according to an embodiment of the present disclosure proposes a structure that enables an easy control of the charging/discharging balance of a flying capacitor so as to prevent the occurrence of such a problem.

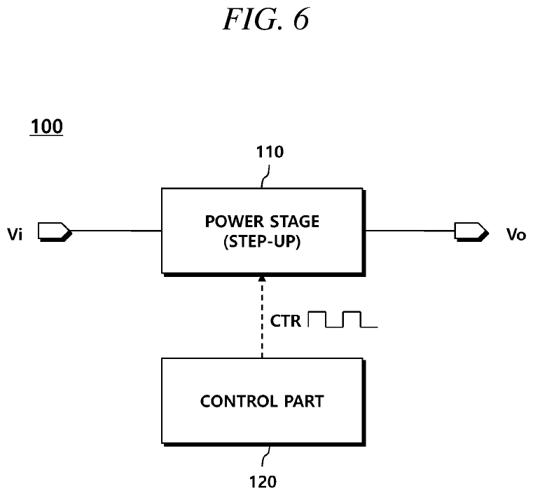

FIG. 6 is a configuration diagram of a step-up converter to which embodiments can be applied.

Referring to FIG. 6, a step-up converter 100 may include a power stage 110 and a control unit (part) 120.

The power stage 110 may include an inductor and a plurality of switches.

The control unit 120 may transmit a control signal CTR to the power stage 110 so as to control the on/off states of the plurality of switches. The power stage 110 may be operated as a multilevel step-up converter depending on the on/off states of the switches.

The power stage 110 may be operated as a multilevel step-up converter, and may generate an output voltage (Vo) to be higher than an input output (Vi).

Hereinafter, the configuration and state of the power stage 110 will be mainly described, and it may be understood that the switches of the power stage 110 are controlled by the control unit 120.

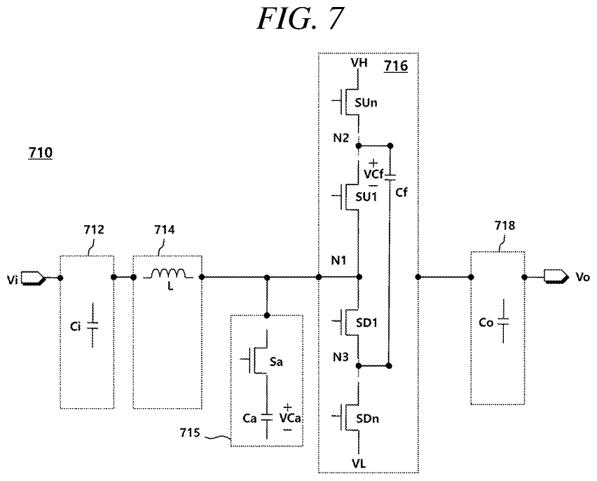

FIG. 7 is a first exemplary configuration diagram illustrating a power stage of a step-up converter according to an embodiment.

Referring to FIG. 7, a power stage 710 may include an input unit 712, an inductor unit 714, an auxiliary capacitor 715, a power switch unit 716, an output unit 718, and the like.

The input unit 712 may include at least one input capacitor Ci. An input voltage (Vi) is supplied to one side of the input capacitor Ci, and the other side of the input capacitor Ci may be connected to the ground.

The inductor unit 714 may include at least one inductor L. One side of the inductor unit 714 is connected to the input unit 712, and the input voltage (Vi) may be received from the input unit 712.

The auxiliary capacitor 715 may include an auxiliary switch Sa and an auxiliary capacitor Ca that are connected in series. One side of the auxiliary capacitor unit 715 may be connected to a first node N1 and the other side may be connected to the ground. Here, the first node N1 is a node connected to the other side of the inductor unit 714. Connection of the auxiliary capacitor Ca to the first node N1 may be controlled according to turning on/off of the auxiliary switch Sa.

The power switch unit 716 may include at least four serially connected power switches SU1 to SUn and SD1 to SDn. The power switch unit 716 may include at least two power switches SU1 to SUn on the high voltage side and may include at least two power switches SD1 to SDn on the low voltage side with respect to the first node N1 connected to the inductor unit 714.

One end of the at least four serially connected power switches SU1 to SUn and SD1 to SDn may be connected to a high voltage (VH) and the other end thereof may be connected to a low voltage (VL). The high voltage (VH) may be an output voltage (Vo) and the low voltage (VL) may be voltage generated in the ground. In the present specification, the ground or the ground voltage may be understood as an example of the low voltage (VL) described above.

One side of the inductor unit 714 may be connected to the input unit 712, and the other side may be connected to the first node N1 of the power switch unit 716. For example, one side of the inductor L included in the inductor unit 714 may be connected to the input unit 712, and the other side may be connected to the first node N1 of the power switch unit 716.

The power switch unit 716 may include at least one flying capacitor Cf. The flying capacitor Cf may be connected in parallel to at least two power switches among the at least four power switches SU1 to SUn and SD1 to SDn included in the power switch unit 716. For example, both ends of the flying capacitor Cf may be connected to a second node N2 formed between the at least two power switches SU1 to SUn disposed on the high voltage side, and may be connected to a third node N3 formed between the at least two power switches SD1 to SDn disposed on the low voltage side with respect to the first node N1. According to this connection, the flying capacitor Cf may be connected in parallel to a plurality of switches disposed between the second node N2 and the third node N3. Further, the first node N1 formed between the power switches connected in parallel to the flying capacitor Cf may be connected to the other side of the inductor unit 714.

The output unit 718 may include an output capacitor Co. An output voltage (Vo) is supplied to one side of the output capacitor Co, and the other side of the output capacitor Co may be connected to the ground.

The control unit (refer to reference numeral 120 in FIG. 6) may control the power switch unit 716 so as to convert the input voltage (Vi) into the output voltage (Vo).

The control unit (refer to reference numeral 120 in FIG. 6) may control the power switch unit 716 in each control period so that voltage of the first node N1 changes four times or more.

As a first exemplary control, the control unit (refer to reference numeral 120 in FIG. 6) may generate a low voltage (VL) in the first node N1 in the first time interval, and may generate, in the first node N1, voltage obtained by subtracting the voltage (Vcf) of the flying capacitor from a high voltage (VH) in the second time interval. The control unit (refer to reference numeral 120 in FIG. 6) may generate the low voltage (VL) in the first node N1 in the third time interval, and may generate, in the first node N1, voltage obtained by adding the voltage (Vcf) of the flying capacitor to the low voltage (VL) in the fourth time interval. Herein, the high voltage (VH) may be the output voltage (Vo) and the low voltage (VL) may be voltage generated in the ground.

As a second exemplary control, the control unit (refer to reference numeral 120 in FIG. 6) may generate a low voltage (VL) in the first node N1 in the first time interval, and may generate, in the first node N1, voltage obtained by adding the voltage (Vcf) of the flying capacitor to the low voltage (VL) in the second time interval. The control unit (refer to reference numeral 120 in FIG. 6) may generate the low voltage (VL) in the first node N1 in the third time interval, and may generate, in the first node N1, voltage obtained by subtracting the voltage (Vcf) of the flying capacitor from the high voltage (VH) in the fourth time interval. Herein, the high voltage (VH) may be the output voltage (Vo) and the low voltage (VL) may be voltage generated in the ground.

As a third exemplary control, the control unit (refer to reference numeral 120 in FIG. 6) may generate voltage obtained by subtracting the voltage (Vcf) of the flying capacitor from a high voltage (VH) in the first node N1 in the first time interval, and may generate the high voltage (VH) in the first node N1 in the second time interval. The control unit (refer to reference numeral 120 in FIG. 6) may generate, in the first node N1, voltage obtained by adding the voltage (Vcf) of the flying capacitor to a low voltage (VL) in the third time interval, and may generate the high voltage (VH) in the first node N1 in the fourth time interval. Herein, the high voltage (VH) may be the output voltage (Vo) and the low voltage (VL) may be voltage generated in the ground.

As a fourth exemplary control, the control unit (refer to reference numeral 120 in FIG. 6) may generate, in the first node N1, voltage obtained by adding the voltage (Vcf) of the flying capacitor to a low voltage (VL) in the first time interval, and may generate a high voltage (VH) in the first node N1 in the second time interval. The control unit (refer to reference numeral 120 in FIG. 6) may generate, in the first node N1, voltage obtained by subtracting the voltage (Vcf) of the flying capacitor from the high voltage (VH) in the third time interval, and may generate the high voltage (VH) in the first node N1 in the fourth interval. Herein, the high voltage (VH) may be the output voltage (Vo) and the low voltage (VL) may be voltage generated in the ground.

The control unit (refer to reference numeral 120 in FIG. 6) may connect the flying capacitor Cf and the auxiliary capacitor Ca in parallel in one time interval and may connect the flying capacitor Cf and the auxiliary capacitor Ca in series in another time interval of each control period.

When the flying capacitor Cf and the auxiliary capacitor Ca are connected in parallel, the flying capacitor Cf and the auxiliary capacitor Ca may share electric charges and the voltage (Vcf) of the flying capacitor and the voltage (Vca) of the auxiliary capacitor may be equalized.

When the flying capacitor Cf and the auxiliary capacitor Ca are connected in series, the output voltage (Vo) is distributed to the flying capacitor Cf and the auxiliary capacitor Ca, and the voltage (Vcf) of the flying capacitor may be constantly maintained in each control period. When the flying capacitor Cf and the auxiliary capacitor Ca are connected in series, the flying capacitor Cf and the auxiliary capacitor Ca may be connected in parallel to the output capacitor Co, and the output voltage (Vo) may be distributedly generated in the flying capacitor Cf and the auxiliary capacitor Ca according to such a connection structure.

The connection of the flying capacitor Cf and the auxiliary capacitor Ca may be controlled according to turning on/off of the auxiliary switch Sa. The connection of the flying capacitor Cf and the auxiliary capacitor Ca may be made when the auxiliary switch Sa is turned on, and the connection of the flying capacitor Cf and the auxiliary capacitor Ca may be released when the auxiliary switch Sa is turned off.

The control unit (refer to reference numeral 120 in FIG. 6) may connect the flying capacitor Cf and the auxiliary capacitor Ca when the flying capacitor Cf is charged or discharged.

For example, in the described first exemplary control, the flying capacitor Cf may be discharged in the second time interval and may be charged in the fourth time interval, wherein the control unit (refer to reference numeral 120 in FIG. 6) may connect the flying capacitor Cf and the auxiliary capacitor Ca in series in the second time interval, and may connect the flying capacitor Cf and the auxiliary capacitor Ca in parallel in the fourth time interval.

As another example, in the described second exemplary control, the flying capacitor Cf may be charged in the second time interval and may be discharged in the fourth time interval, wherein the control unit (refer to reference numeral 120 in FIG. 6) may connect the flying capacitor Cf and the auxiliary capacitor Ca in parallel in the second time interval, and may connect the flying capacitor Cf and the auxiliary capacitor Ca in series in the fourth time interval.

As still another example, in the described third exemplary control, the flying capacitor Cf may be discharged in the first time interval and may be charged in the third time interval, wherein the control unit (refer to reference numeral 120 in FIG. 6) may connect the flying capacitor Cf and the auxiliary capacitor Ca in series in the first time interval, and may connect the flying capacitor Cf and the auxiliary capacitor Ca in parallel in the third time interval.

As still another example, in the described fourth exemplary control, the flying capacitor Cf may be charged in the first time interval and may be discharged in the third time interval, wherein the control unit (refer to reference numeral 120 in FIG. 6) may connect the flying capacitor Cf and the auxiliary capacitor Ca in parallel in the first time interval, and may connect the flying capacitor Cf and the auxiliary capacitor Ca in series in the third time interval.

Depending on a control method, the control unit (refer to reference numeral 120 in FIG. 6) may control the voltage (Vcf) of the flying capacitor to be varied at ½ of the output voltage (Vo). The voltage (Vcf) of the flying capacitor may be slightly higher than ½ of the output voltage (Vo) in an interval in which the floating capacitor Cf is charged, and the voltage (Vcf) of the flying capacitor may be slightly lower than ½ of the output voltage (Vo) in an interval in which the floating capacitor Cf is discharged. However, the voltage (Vcf) of the flying capacitor may be substantially the same in the same time interval of each control period.

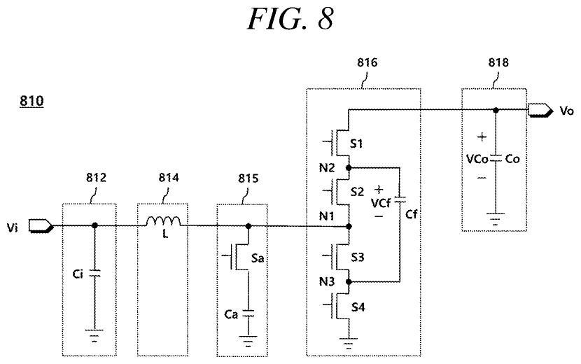

FIG. 8 is a second exemplary configuration diagram illustrating a power stage of a step-up converter according to an embodiment.

Referring to FIG. 8, a power stage 810 may include an input unit 812, an inductor unit 814, an auxiliary capacitor 815, a power switch unit 816, an output unit 818, and the like.

The input unit 812 may include at least one input capacitor Ci. An input voltage (Vi) is supplied to one side of the input capacitor Ci, and the other side of the input capacitor Ci may be connected to the ground.

The output unit 818 may include at least one output capacitor Co. An output voltage (Vo) is supplied to one side of the output capacitor Co, and the other side of the output capacitor Co may be connected to the ground.

The inductor unit 814 may include at least one inductor L. One side of the inductor unit L may be connected to the input capacitor Ci so as to receive an input voltage (Vi), and the other side of the inductor unit L may be connected to the first node N1.

The auxiliary capacitor 815 may include an auxiliary switch Sa and an auxiliary capacitor Ca that are connected in series. One side of the auxiliary switch Sa may be connected to the first node N1 and the other side may be connected to the auxiliary capacitor Ca. One side of the auxiliary capacitor Ca may be connected to the auxiliary switch Sa and the other side may be connected to the ground.

The power switch unit 816 may include four serially connected switches S1 to S4. The power switch unit 816 may include a flying capacitor Cf connected in parallel to the second switch S2 and the third switch S3.

One side of the first switch S1 may be connected to an output capacitor Co and the other side may be connected to the second node N2. One side of the second switch S2 may be connected to the second node N2, and the other side may be connected to the first node N1. One side of the third switch S3 may be connected to the first node N1, and the other side may be connected to a third node N3. One side of the fourth switch S4 may be connected to the third node N3, and the other side may be connected to the ground.

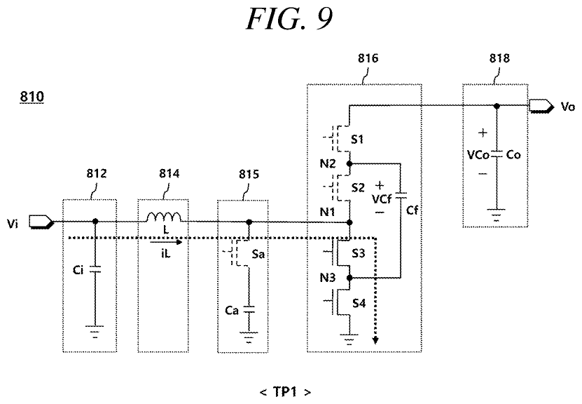

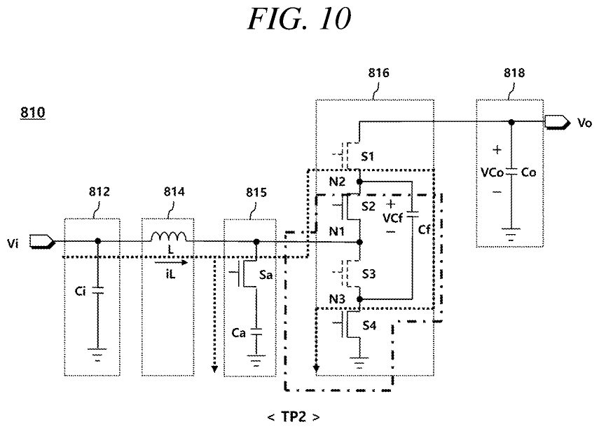

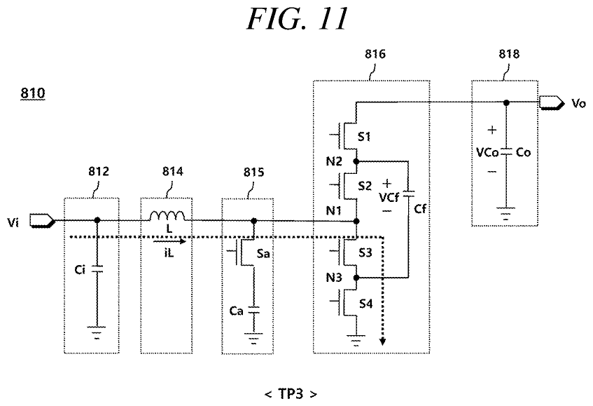

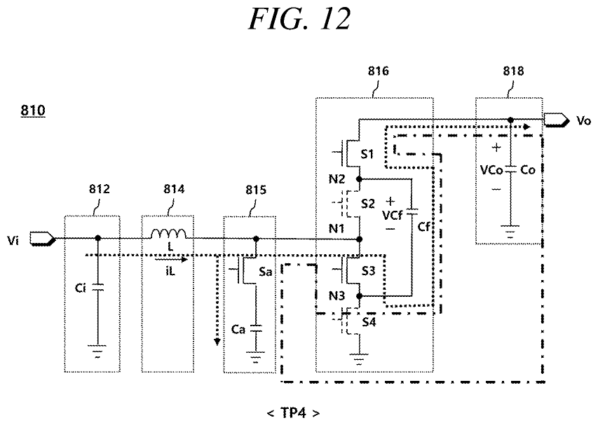

FIG. 9 is a first time interval state diagram illustrating a time at which the power stage according to a second example of an embodiment is controlled by a first control method, and FIG. 10 is a second time interval state diagram illustrating the time at which the power stage according to the second example of the embodiment is controlled by the first control method. FIG. 11 is a third time interval state diagram illustrating the time at which the power stage according to the second example of the embodiment is controlled by the first control method, and FIG. 12 is a fourth time interval state diagram illustrating the time at which the power stage according to the second example of the embodiment is controlled by the first control method.

Referring to FIG. 9 to FIG. 12, a control unit (refer to reference numeral 120 in FIG. 6) may divide each control period sequentially into a first time interval (TP1), a second time interval (TP2), a third time interval (TP3), and a fourth time interval (TP4) so as to control the same.

The control unit (refer to reference numeral 120 in FIG. 6) may turn on the third switch S3 and the fourth switch S4 so as to build up the current (iL) of the inductor L in the first time interval (TP1) and the third time interval (TP3).

The control unit (refer to reference numeral 120 in FIG. 6) may turn off the first switch S1 and the second switch S2 in the first time interval (TP1) and the third time interval (TP3) so as to prevent the inductor current (iL) from flowing to the output capacitor Co and allow the flying capacitor Cf to float.

The control unit (refer to reference numeral 120 in FIG. 6) may turn off the two auxiliary switch Sa so as to allow the auxiliary capacitor Ca to be floated as well.

The control unit (refer to reference numeral 120 in FIG. 6) may turn off the first switch S1 and the third switch S3 and may turn on the second switch S2 and the fourth switch S4, in the second time interval (TP2). According to this control, the inductor current (iL) may be transferred to the ground while charging the flying capacitor Cf.

The control unit (refer to reference numeral 120 in FIG. 6) may turn on the auxiliary switch Sa in the second time interval (TP2). When the auxiliary switch Sa is turned on, the flying capacitor Cf and the auxiliary capacitor Ca may be connected in parallel and may share electric charges with each other. The voltage of the flying capacitor Cf and the voltage of the auxiliary capacitor Ca may be equalized.

The control unit (refer to reference numeral 120 in FIG. 6) may turn on the first switch S1 and the third switch S3 and may turn off the second switch S2 and the fourth switch S4 in the fourth time interval (TP4). According to this control, the inductor current (iL) may be transferred to the output capacitor Co while discharging the flying capacitor Cf.

The control unit (refer to reference numeral 120 in FIG. 6) may turn on the auxiliary switch Sa in the fourth time interval (TP4). When the auxiliary switch Sa is turned on, the flying capacitor Cf and the auxiliary capacitor Ca may be connected in series.

When a terminal at which a relatively high voltage is generated in the flying capacitor Cf is referred to as a positive terminal, and a terminal at which a relatively low voltage is generated is referred to as a negative terminal, the positive terminal of the flying capacitor Cf may be connected to the second node N2 and the negative terminal may be connected to the third node N3. When the flying capacitor Cf and the auxiliary capacitor Ca are serially connected in the fourth time interval (TP4), the positive terminal of the flying capacitor Cf may be connected to the output capacitor Co, and the negative terminal of the flying capacitor Cf may be connected to the auxiliary capacitor Ca through the first node N1. Further, one side of the output capacitor Co may be connected to the positive terminal of the flying capacitor Cf and the other side may be connected to the ground, and one side of the auxiliary capacitor Ca may be connected to the negative terminal of the flying capacitor Cf and the other side may be connected to the ground.

According to such a connection structure, the output voltage (Vo) may be distributedly generated in the flying capacitor Cf and the auxiliary capacitor Ca. Assuming that the capacity of the output capacitor Co is sufficiently large, it may be assumed that the output voltage (Vo) is kept constant. According to this assumption, the output voltage (Vo) may be distributed, in inverse proportion, to the respective capacitances of the flying capacitor Cf and the auxiliary capacitor Ca. If the output voltage (Vo) is controlled to be constant in each control period, the voltage of the flying capacitor Cf and the voltage of the auxiliary capacitor Ca may be maintained constant in each control period.

According to the first control method of this embodiment, three or more voltage levels may be generated in the first node N1 connected to the inductor L, for example, a level of the ground voltage, a voltage level obtained by subtracting the voltage (Vcf) of the flying capacitor from the output voltage (Vo), and a voltage level obtained by adding the voltage (Vcf) of the flying capacitor to the ground voltage may be generated in the first node N1.

This control method may be referred to as a multilevel step-up control. According to the first control method of an embodiment, the output voltage (Vo) may be at least two times higher than the input voltage (Vi).

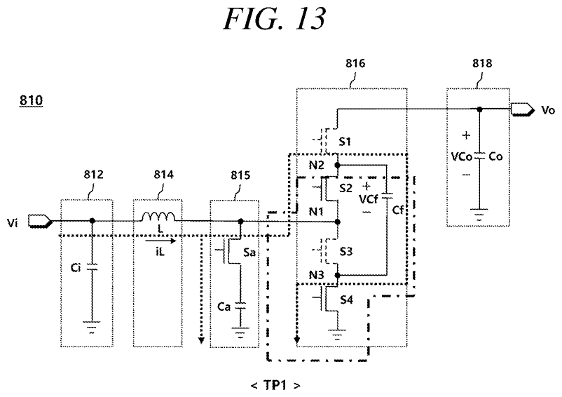

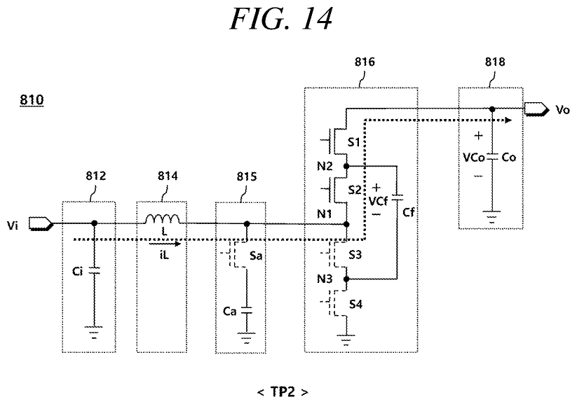

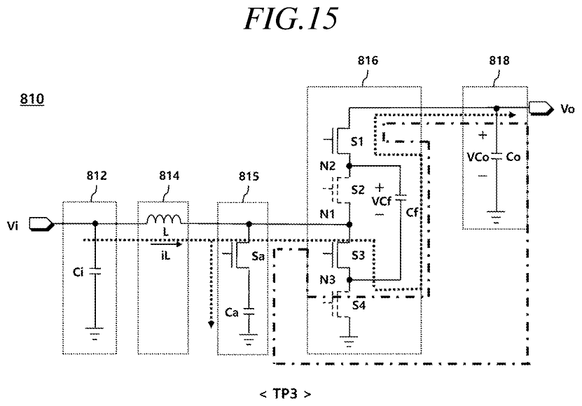

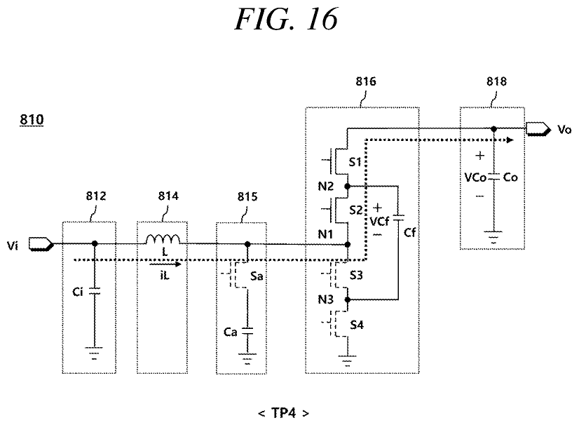

FIG. 13 is a first time interval state diagram illustrating a time at which the power stage according to the second example of the embodiment is controlled by a second control method, and FIG. 14 is a second time interval state diagram illustrating the time at which the power stage according to the second example of the embodiment is controlled by the second control method. FIG. 15 is a third time interval state diagram illustrating the time at which the power stage according to the second example of the embodiment is controlled by the second control method, and FIG. 16 is a fourth time interval state diagram illustrating the time at which the power stage according to the second example of the embodiment is controlled by the second control method.

Referring to FIG. 13 to FIG. 16, a control unit (refer to reference numeral 120 in FIG. 6) may divide each control period sequentially into a first time interval (TP1), a second time interval (TP2), a third time interval (TP3), and a fourth time interval (TP4) so as to control the same.

The control unit (refer to reference numeral 120 in FIG. 6) may turn off the first switch S1 and the third switch S3 and may turn on the second switch S2 and the fourth switch S4, in the first time interval (TP1). According to this control, the inductor current (iL) may be transferred to the ground while charging the flying capacitor Cf.

The control unit (refer to reference numeral 120 in FIG. 6) may turn on the auxiliary switch Sa in the first time interval (TP1). When the auxiliary switch Sa is turned on, the flying capacitor Cf and the auxiliary capacitor Ca may be connected in parallel and may share electric charges with each other. The voltage of the flying capacitor Cf and the voltage of the auxiliary capacitor Ca may be equalized.

The control unit (refer to reference numeral 120 in FIG. 6) may turn on the first switch S1 and the second switch S2 so as to build up the output voltage (Vo) in the first node N1 connected to the inductor L, in the second time interval (TP2) and the fourth time interval (TP4).

The control unit (refer to reference numeral 120 in FIG. 6) may turn off the third switch S3 and the fourth switch S4 so as to prevent the inductor current (iL) from flowing to the ground and allow the flying capacitor Cf to float, in the second time interval (TP2) and the fourth time interval (TP4).

The control unit (refer to reference numeral 120 in FIG. 6) may turn off the auxiliary switch Sa so as to allow the auxiliary capacitor Ca to be floated as well.

The control unit (refer to reference numeral 120 in FIG. 6) may turn on the first switch S1 and the third switch S3 and may turn off the second switch S2 and the fourth switch S4 in the third time interval (TP3). According to this control, the inductor current (iL) may be transferred to the output capacitor Co while discharging the flying capacitor Cf.

The control unit (refer to reference numeral 120 in FIG. 6) may turn on the auxiliary switch Sa in the third time interval (TP3). When the auxiliary switch Sa is turned on, the flying capacitor Cf and the auxiliary capacitor Ca may be connected in series.

When the flying capacitor Cf and the auxiliary capacitor Ca are serially connected in the third time interval (TP3), the positive terminal of the flying capacitor Cf may be connected to the output capacitor Co, and the negative terminal of the flying capacitor Cf may be connected to the auxiliary capacitor Ca through the first node N1. Further, one side of the output capacitor Co may be connected to the positive terminal of the flying capacitor Cf and the other side may be connected to the ground, and one side of the auxiliary capacitor Ca may be connected to the negative terminal of the flying capacitor Cf and the other side may be connected to the ground.

According to this second control method, three or more voltage levels may be generated in the first node N1 connected to the inductor L, for example, a level of the output voltage (Vo), a voltage level obtained by subtracting the voltage (Vcf) of the flying capacitor from the output voltage (Vo), and a voltage level obtained by adding the voltage (Vcf) of the flying capacitor to the ground voltage may be generated in the first node N1.

According to the second control method of the embodiment, the output voltage (Vo) may be equal to or higher than the input voltage (Vi) and lower than twice the input voltage (Vi).

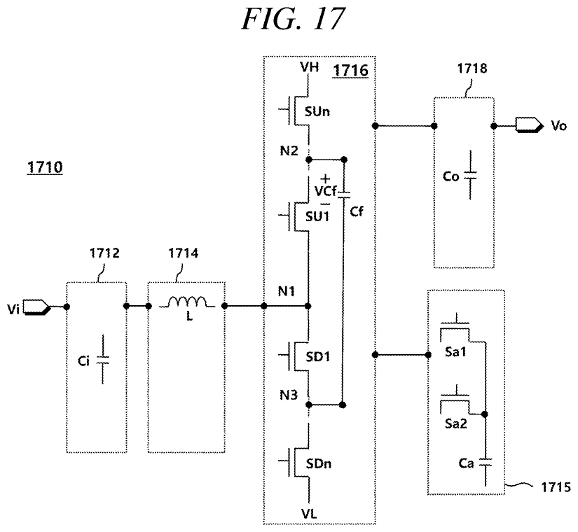

FIG. 17 is a first exemplary configuration diagram illustrating a power stage of a step-up converter according to another embodiment.

Referring to FIG. 17, a power stage 1710 may include an input unit 1712, an inductor unit 1714, an auxiliary capacitor 1715, a power switch unit 1716, an output unit 1718, and the like.

The input unit 1712 may include at least one input capacitor Ci. An input voltage (Vi) is supplied to one side of the input capacitor Ci, and the other side of the input capacitor Ci may be connected to the ground.

The inductor unit 1714 may include at least one inductor L. One side of the inductor unit 1714 is connected to the input unit 1712, and the input voltage (Vi) may be received from the input unit 1712.

The power switch unit 1716 may include at least four serially connected power switches SU1 to SUn and SD1 to SDn. The power switch unit 1716 may include at least two power switches SU1 to SUn on the high voltage side and may include at least two power switches SD1 to SDn on the low voltage side with respect to the first node N1 connected to the inductor unit 1714.

One end of the at least four serially connected power switches SU1 to SUn and SD1 to SDn may be connected to a high voltage (VH) and the other end thereof may be connected to a low voltage (VL). The high voltage (VH) may be an output voltage (Vo) and the low voltage (VL) may be voltage generated in the ground. In the present specification, the ground or the ground voltage may be understood as an example of the low voltage (VL) described above.

One side of the inductor unit 1714 may be connected to the input unit 1712, and the other side may be connected to the first node N1 of the power switch unit 1716. For example, one side of the inductor L included in the inductor unit 1714 may be connected to the input unit 1712, and the other side may be connected to the first node N1 of the power switch unit 1716.

The power switch unit 1716 may include at least one flying capacitor Cf. The flying capacitor Cf may be connected in parallel to at least two power switches among the at least four power switches SU1 to SUn and SD1 to SDn included in the power switch unit 1716. For example, both ends of the flying capacitor Cf may be connected to a second node N2 formed between the at least two power switches SU1 to SUn disposed on the high voltage side, and may be connected to a third node N3 formed between the at least two power switches SD1 to SDn disposed on the low voltage side with respect to the first node N1. According to this connection, the flying capacitor Cf may be connected in parallel to a plurality of switches disposed between the second node N2 and the third node N3. Further, the first node N1 formed between the power switches connected in parallel to the flying capacitor Cf may be connected to the other side of the inductor unit 1714.

The auxiliary capacitor 1715 may include two auxiliary switches Sa1 and Sa2, and an auxiliary capacitor Ca. In the auxiliary capacitor unit 1715, one side of a first auxiliary switch Sa1 may be connected to the positive terminal of the flying capacitor Cf, and the other side may be connected to the auxiliary capacitor Ca. Further, one side of the second auxiliary switch Sa2 may be connected to the negative terminal of the flying capacitor Cf, and the other side may be connected to the auxiliary capacitor Ca. In another aspect, one side of the first auxiliary switch Sa1 may be connected to the second node N2, and the other side may be connected to the auxiliary capacitor Ca. Further, one side of the second auxiliary switch Sa2 may be connected to the third node N3, and the other side may be connected to the auxiliary capacitor Ca. One side of the auxiliary capacitor Ca may be connected to the first auxiliary switch Sa1 and the second auxiliary switch Sa2, and the other side may be connected to the ground.

The output unit 1718 may include an output capacitor Co. An output voltage (Vo) is supplied to one side of the output capacitor Co, and the other side of the output capacitor Co may be connected to the ground.

The control unit (refer to reference numeral 120 in FIG. 6) may control the power switch unit 1716 so as to convert the input voltage (Vi) into the output voltage (Vo).

The control unit (refer to reference numeral 120 in FIG. 6) may control the power switch unit 1716 in each control period so that voltage of the first node N1 changes four times or more.

As a first exemplary control, the control unit (refer to reference numeral 120 in FIG. 6) may generate a low voltage (VL) in the first node N1 in the first time interval, and may generate, in the first node N1, voltage obtained by subtracting the voltage (Vcf) of the flying capacitor from a high voltage (VH) in the second time interval. The control unit (refer to reference numeral 120 in FIG. 6) may generate the low voltage (VL) in the first node N1 in the third time interval, and may generate, in the first node N1, voltage obtained by adding the voltage (Vcf) of the flying capacitor to the low voltage (VL) in the fourth time interval. Herein, the high voltage (VH) may be the output voltage (Vo) and the low voltage (VL) may be voltage generated in the ground.

As a second exemplary control, the control unit (refer to reference numeral 120 in FIG. 6) may generate a low voltage (VL) in the first node N1 in the first time interval, and may generate, in the first node N1, voltage obtained by adding the voltage (Vcf) of the flying capacitor to the low voltage (VL) in the second time interval. The control unit (refer to reference numeral 120 in FIG. 6) may generate the low voltage (VL) in the first node N1 in the third time interval, and may generate, in the first node N1, voltage obtained by subtracting the voltage (Vcf) of the flying capacitor from the high voltage (VH) in the fourth time interval. Herein, the high voltage (VH) may be the output voltage (Vo) and the low voltage (VL) may be voltage generated in the ground.

As a third exemplary control, the control unit (refer to reference numeral 120 in FIG. 6) may generate voltage obtained by subtracting the voltage (Vcf) of the flying capacitor from a high voltage (VH) in the first node N1 in the first time interval, and may generate the high voltage (VH) in the first node N1 in the second time interval. The control unit (refer to reference numeral 120 in FIG. 6) may generate, in the first node N1, voltage obtained by adding the voltage (Vcf) of the flying capacitor to a low voltage (VL)in the third time interval, and may generate the high voltage (VH) in the first node N1 in the fourth time interval. Herein, the high voltage (VH) may be the output voltage (Vo) and the low voltage (VL) may be voltage generated in the ground.

As a fourth exemplary control, the control unit (refer to reference numeral 120 in FIG. 6) may generate, in the first node N1, voltage obtained by adding the voltage (Vcf) of the flying capacitor to a low voltage (VL) in the first time interval, and may generate a high voltage (VH) in the first node N1 in the second time interval. The control unit (refer to reference numeral 120 in FIG. 6) may generate, in the first node N1, voltage obtained by subtracting the voltage (Vcf) of the flying capacitor from the high voltage (VH) in the third time interval, and may generate the high voltage (VH) in the first node N1 in the fourth interval. Herein, the high voltage (VH) may be the output voltage (Vo) and the low voltage (VL) may be voltage generated in the ground.

The control unit (refer to reference numeral 120 in FIG. 6) may connect the flying capacitor Cf and the auxiliary capacitor Ca in parallel in one time interval and may connect the flying capacitor Cf and the auxiliary capacitor Ca in series in another time interval of each control period.

When the flying capacitor Cf and the auxiliary capacitor Ca are connected in parallel, the flying capacitor Cf and the auxiliary capacitor Ca may share electric charges and the voltage (Vcf) of the flying capacitor and the voltage (Vca) of the auxiliary capacitor may be equalized.

When the flying capacitor Cf and the auxiliary capacitor Ca are connected in series, the output voltage (Vo) is distributed to the flying capacitor Cf and the auxiliary capacitor Ca, and the voltage (Vcf) of the flying capacitor may be constantly maintained in each control period. When the flying capacitor Cf and the auxiliary capacitor Ca are connected in series, the flying capacitor Cf and the auxiliary capacitor Ca may be connected in parallel to the output capacitor Co, and the output voltage (Vo) may be distributedly generated in the flying capacitor Cf and the auxiliary capacitor Ca according to such a connection structure.

The connection of the flying capacitor Cf and the auxiliary capacitor Ca may be controlled according to turning on/off of the auxiliary switches Sa1 and Sa2. The flying capacitor Cf and the auxiliary capacitor Ca may be connected in parallel when the first auxiliary switch Sa1 is turned on, and the flying capacitor Cf and the auxiliary capacitor Ca may be connected in series when the second auxiliary switch Sa2 is turned on. When both the first auxiliary switch Sa1 and the second auxiliary switch Sa2 are turned off, the flying capacitor Cf and the auxiliary capacitor Ca may be disconnected.

The control unit (refer to reference numeral 120 in FIG. 6) may connect the flying capacitor Cf and the auxiliary capacitor Ca when the flying capacitor Cf is charged or discharged.

For example, in the described first exemplary control, the flying capacitor Cf may be discharged in the second time interval and may be charged in the fourth time interval, wherein the control unit (refer to reference numeral 120 in FIG. 6) may connect the flying capacitor Cf and the auxiliary capacitor Ca in series in the second time interval, and may connect the flying capacitor Cf and the auxiliary capacitor Ca in parallel in the fourth time interval.

As another example, in the described second exemplary control, the flying capacitor Cf may be charged in the second time interval and may be discharged in the fourth time interval, wherein the control unit (refer to reference numeral 120 in FIG. 6) may connect the flying capacitor Cf and the auxiliary capacitor Ca in parallel in the second time interval, and may connect the flying capacitor Cf and the auxiliary capacitor Ca in series in the fourth time interval.

As another example, in the described third exemplary control, the flying capacitor Cf may be discharged in the first time interval and may be charged in the third time interval, wherein the control unit (refer to reference numeral 120 in FIG. 6) may connect the flying capacitor Cf and the auxiliary capacitor Ca in series in the first time interval, and may connect the flying capacitor Cf and the auxiliary capacitor Ca in parallel in the third time interval.

For still another example, in the described fourth exemplary control, the flying capacitor Cf may be charged in the first time interval and may be discharged in the third time interval, wherein the control unit (refer to reference numeral 120 in FIG. 6) may connect the flying capacitor Cf and the auxiliary capacitor Ca in parallel in the first time interval, and may connect the flying capacitor Cf and the auxiliary capacitor Ca in series in the third time interval.

Depending on a control method, the control unit (refer to reference numeral 120 in FIG. 6) may control the voltage (Vcf) of the flying capacitor to be varied at ½ of the output voltage (Vo). The voltage (Vcf) of the flying capacitor may be slightly higher than ½ of the output voltage (Vo) in an interval in which the floating capacitor Cf is charged, and the voltage (Vcf) of the flying capacitor may be slightly lower than ½ of the output voltage (Vo) in an interval in which the floating capacitor Cf is discharged. However, the voltage (Vcf) of the flying capacitor may be substantially the same in the same time interval of each control period.

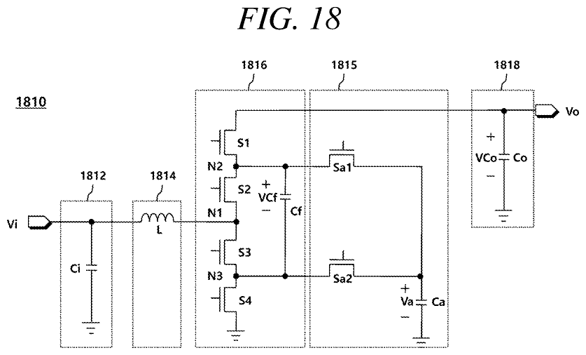

FIG. 18 is a second exemplary configuration diagram illustrating a power stage of a step-up converter according to another embodiment.

Referring to FIG. 18, a power stage 1810 may include an input unit 1812, an inductor unit 1814, an auxiliary capacitor 1815, a power switch unit 1816, an output unit 1818, and the like.

The input unit 1812 may include at least one input capacitor Ci. An input voltage (Vi) is supplied to one side of the input capacitor Ci, and the other side of the input capacitor Ci may be connected to the ground.

The output unit 1818 may include at least one output capacitor Co. An output voltage (Vo) is supplied to one side of the output capacitor Co, and the other side of the output capacitor Co may be connected to the ground.

The inductor unit 1814 may include at least one inductor L. One side of the inductor unit L may be connected to the input capacitor Ci so as to receive an input voltage (Vi), and the other side of the inductor unit L may be connected to the first node N1.

The power switch unit 1816 may include four serially connected switches S1 to S4. The power switch unit 1816 may include a flying capacitor Cf connected in parallel to the second switch S2 and the third switch S3.

One side of the first switch S1 may be connected to an output capacitor Co and the other side may be connected to the second node N2. One side of the second switch S2 may be connected to the second node N2, and the other side may be connected to the first node N1. One side of the third switch S3 may be connected to the first node N1, and the other side may be connected to a third node N3. One side of the fourth switch S4 may be connected to the third node N3, and the other side may be connected to the ground.

The auxiliary capacitor 1815 may include two auxiliary switches Sa1 and Sa2, and an auxiliary capacitor Ca. One side of the first auxiliary switch Sa1 may be connected to the positive terminal—the second node N2—of the flying capacitor Cf, and the other side may be connected to the auxiliary capacitor Ca. One side of the second auxiliary switch Sa2 may be connected to the negative terminal—the third node N3—of the flying capacitor Cf, and the other side may be connected to the auxiliary capacitor Ca. One side of the auxiliary capacitor Ca may be connected to the first auxiliary switch Sa1 and the second auxiliary switch Sa2, and the other side may be connected to the ground.

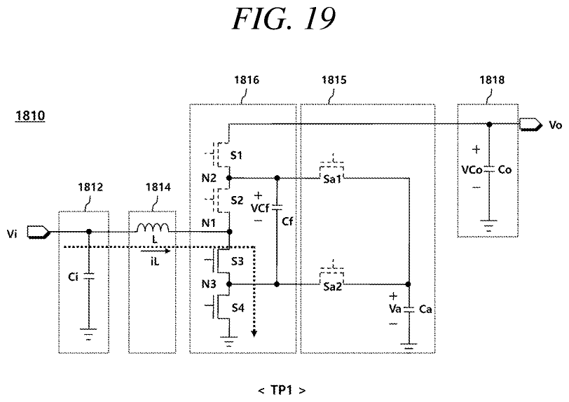

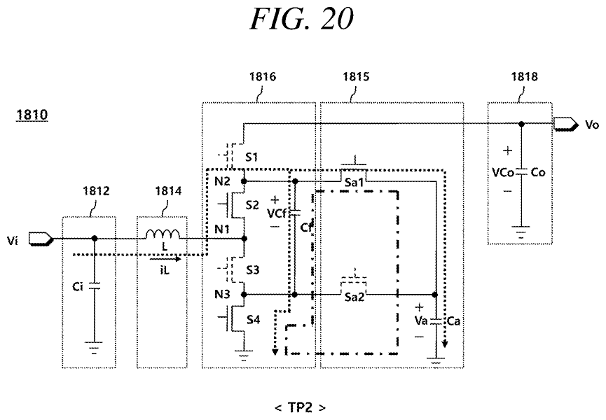

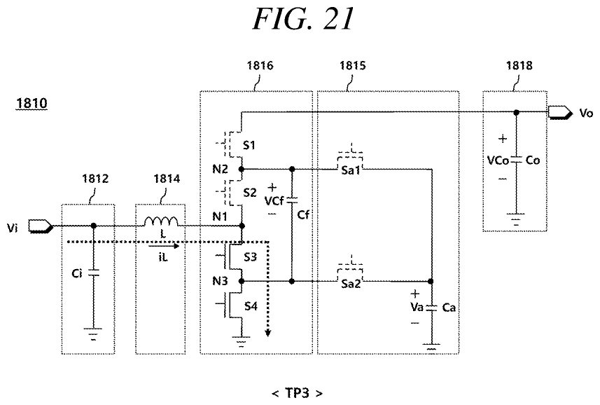

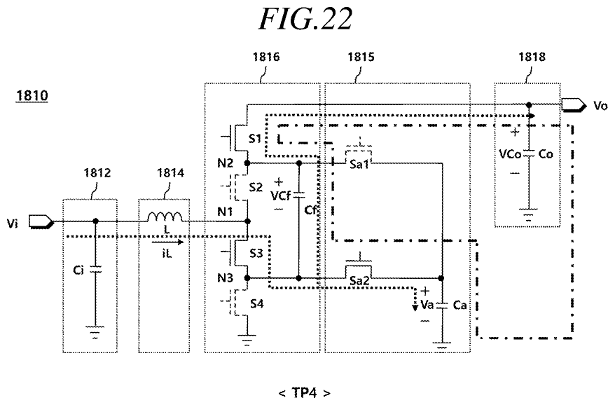

FIG. 19 is a first time interval state diagram illustrating a time at which the power stage according to a second example of another embodiment is controlled by a first control method, and FIG. 20 is a second time interval state diagram illustrating the time at which the power stage according to the second example of the another embodiment is controlled by the first control method. FIG. 21 is a third time interval state diagram illustrating the time at which the power stage according to the second example of the another embodiment is controlled by the first control method, and FIG. 22 is a fourth time interval state diagram illustrating the time at which the power stage according to the second example of the another embodiment is controlled by the first control method.

Referring to FIG. 19 to FIG. 22, a control unit (refer to reference numeral 120 in FIG. 6) may divide each control period sequentially into a first time interval (TP1), a second time interval (TP2), a third time interval (TP3), and a fourth time interval (TP4) so as to control the same.

The control unit (refer to reference numeral 120 in FIG. 6) may turn on the third switch S3 and the fourth switch S4 so as to build up the current (iL) of the inductor L in the first time interval (TP1) and the third time interval (TP3).

The control unit (refer to reference numeral 120 in FIG. 6) may turn off the first switch S1 and the second switch S2 in the first time interval (TP1) and the third time interval (TP3) so as to prevent the inductor current (iL) from flowing to the output capacitor Co and allow the flying capacitor Cf to float.

The control unit (refer to reference numeral 120 in FIG. 6) may turn off the two auxiliary switches Sa1 and Sa2 so as to allow the auxiliary capacitor Ca to be floated as well.

The control unit (refer to reference numeral 120 in FIG. 6) may turn off the first switch S1 and the third switch S3 and may turn on the second switch S2 and the fourth switch S4, in the second time interval (TP2). According to this control, the inductor current (iL) may be transferred to the ground while charging the flying capacitor Cf.

The control unit (refer to reference numeral 120 in FIG. 6) may turn on the first auxiliary switch Sa1 and may turn off the second auxiliary switch Sa2 in the second time interval (TP2). When the first auxiliary switch Sa1 is turned on, the flying capacitor Cf and the auxiliary capacitor Ca may be connected in parallel and may share electric charges with each other. The voltage of the flying capacitor Cf and the voltage of the auxiliary capacitor Ca may be equalized.

The control unit (refer to reference numeral 120 in FIG. 6) may turn on the first switch S1 and the third switch S3 and may turn off the second switch S2 and the fourth switch S4 in the fourth time interval (TP4). According to this control, the inductor current (iL) may be transferred to the output capacitor Co while discharging the flying capacitor Cf.

The control unit (refer to reference numeral 120 in FIG. 6) may turn off the first auxiliary switch Sa1 and may turn on the second auxiliary switch Sa2 in the fourth time interval (TP4). When the second auxiliary switch Sa2 is turned on, the flying capacitor Cf and the auxiliary capacitor Ca may be connected in series.

When the flying capacitor Cf and the auxiliary capacitor Ca are serially connected in the fourth time interval (TP4), the positive terminal of the flying capacitor Cf may be connected to the output capacitor Co, and the negative terminal of the flying capacitor Cf may be connected to the auxiliary capacitor Ca through the first node NE Further, one side of the output capacitor Co may be connected to the positive terminal of the flying capacitor Cf and the other side may be connected to the ground, and one side of the auxiliary capacitor Ca may be connected to the negative terminal of the flying capacitor Cf and the other side may be connected to the ground.

According to such a connection structure, the output voltage (Vo) may be distributedly generated in the flying capacitor Cf and the auxiliary capacitor Ca. Assuming that the capacity of the output capacitor Co is sufficiently large, it may be assumed that the output voltage (Vo) is kept constant. According to this assumption, the output voltage (Vo) may be distributed, in inverse proportion, to the respective capacitances of the flying capacitor Cf and the auxiliary capacitor Ca. If the output voltage (Vo) is controlled to be constant in each control period, the voltage of the flying capacitor Cf and the voltage of the auxiliary capacitor Ca may be maintained constant in each control period.

According to the first control method of the another embodiment, three or more voltage levels may be generated in the first node N1 connected to the inductor L, for example, a level of the ground voltage, a voltage level obtained by subtracting the voltage (Vcf) of the flying capacitor from the output voltage (Vo), and a voltage level obtained by adding the voltage (Vcf) of the flying capacitor to the ground voltage may be generated in the first node N1.

This control method may be referred to as a multilevel step-up control. According to the first control method of another embodiment, the output voltage (Vo) may be at least two times higher than the input voltage (Vi).

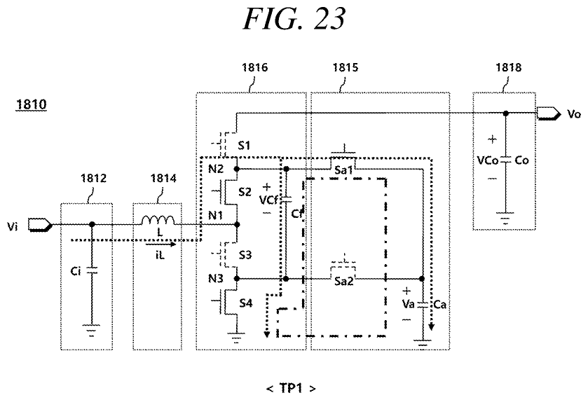

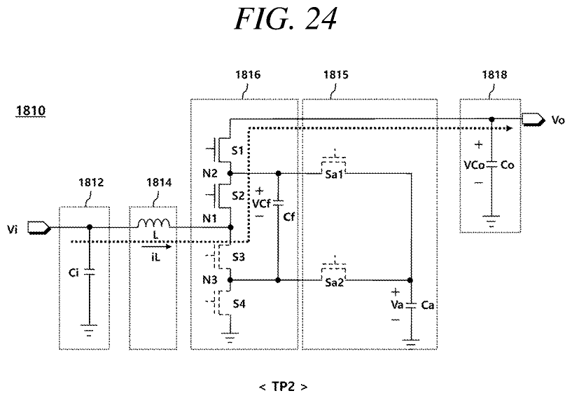

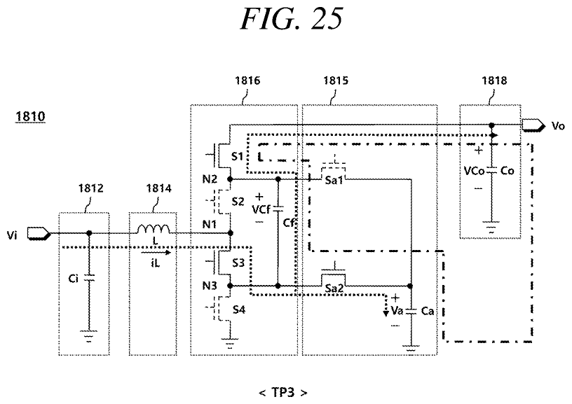

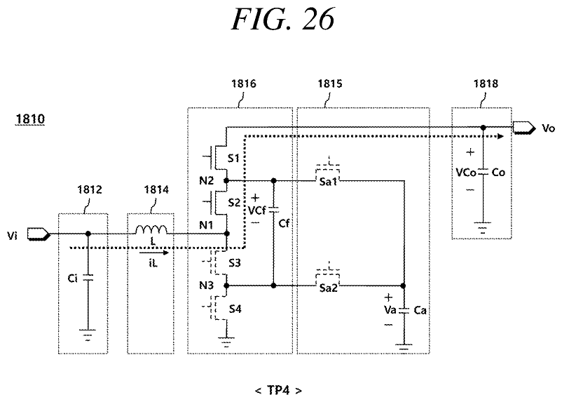

FIG. 23 is a first time interval state diagram illustrating the time at which the power stage according to the second example of the another embodiment is controlled by the second control method, and FIG. 24 is a second time interval state diagram illustrating the time at which the power stage according to the second example of the another embodiment is controlled by the second control method. FIG. 25 is a third time interval state diagram illustrating a time at which the power stage according to a second example of another embodiment is controlled by the second control method, and FIG. 26 is a fourth time interval state diagram illustrating the time at which the power stage according to the second example of the another embodiment is controlled by the second control method.

Referring to FIG. 23 to FIG. 26, a control unit (refer to reference numeral 120 in FIG. 6) may divide each control period sequentially into a first time interval (TP1), a second time interval (TP2), a third time interval (TP3), and a fourth time interval (TP4) so as to control the same.

The control unit (refer to reference numeral 120 in FIG. 6) may turn off the first switch S1 and the third switch S3 and may turn on the second switch S2 and the fourth switch S4, in the first time interval (TP1). According to this control, the inductor current (iL) may be transferred to the ground while charging the flying capacitor Cf.

The control unit (refer to reference numeral 120 in FIG. 6) may turn on the first auxiliary switch Sa1 and may turn off the second auxiliary switch Sa2 in the first time interval (TP1). When the first auxiliary switch Sa1 is turned on, the flying capacitor Cf and the auxiliary capacitor Ca may be connected in parallel and may share electric charges with each other. The voltage of the flying capacitor Cf and the voltage of the auxiliary capacitor Ca may be equalized.

The control unit (refer to reference numeral 120 in FIG. 6) may turn on the first switch S1 and the second switch S2 so as to build up the output voltage (Vo) in the first node N1 connected to the inductor L, in the second time interval (TP2) and the fourth time interval (TP4).

The control unit (refer to reference numeral 120 in FIG. 6) may turn off the third switch S3 and the fourth switch S4 so as to prevent the inductor current (iL) from flowing to the ground and allow the flying capacitor Cf to be floated, in the second time interval (TP2) and the fourth time interval (TP4).

The control unit (refer to reference numeral 120 in FIG. 6) may turn off two auxiliary switches Sa1 and Sa2 so as to allow the auxiliary capacitor Ca to be floated as well.

The control unit (refer to reference numeral 120 in FIG. 6) may turn on the first switch S1 and the third switch S3 and may turn off the second switch S2 and the fourth switch S4 in the third time interval (TP3). According to this control, the inductor current (iL) may be transferred to the output capacitor Co while discharging the flying capacitor Cf.

The control unit (refer to reference numeral 120 in FIG. 6) may turn off the first auxiliary switch Sa1 and may turn on the second auxiliary switch Sa2 in the third time interval (TP3). When the second auxiliary switch Sa2 is turned on, the flying capacitor Cf and the auxiliary capacitor Ca may be connected in series.

When the flying capacitor Cf and the auxiliary capacitor Ca are serially connected in the third time interval (TP3), the positive terminal of the flying capacitor Cf may be connected to the output capacitor Co, and the negative terminal of the flying capacitor Cf may be connected to the auxiliary capacitor Ca through the first node NE Further, one side of the output capacitor Co may be connected to the positive terminal of the flying capacitor Cf and the other side may be connected to the ground, and one side of the auxiliary capacitor Ca may be connected to the negative terminal of the flying capacitor Cf and the other side may be connected to the ground.

According to the second control method of the another embodiment, three or more voltage levels may be generated in the first node N1 connected to the inductor L, for example, a level of the output voltage (Vo), a voltage level obtained by subtracting the voltage (Vcf) of the flying capacitor from the output voltage (Vo), and a voltage level obtained by adding the voltage (Vcf) of the flying capacitor to the ground voltage may be generated in the first node N1.

According to the second control method of the another embodiment, the output voltage (Vo) may be equal to or higher than the input voltage (Vi) and lower than twice the input voltage (Vi).

In the first control method and the second control method in the embodiment, which are described with reference to FIG. 9 to FIG. 16, it is described that one control period is configured by a first time interval (TP1), a second time interval (TP2), a third time interval (TP3), and a fourth time interval (TP4), and a control sequence (TP1→TP2→TP3→TP4) from the first time interval (TP1) to the fourth time interval (TP4) is repeated in a plurality of control periods. However, in some cases, the configuration and control sequence of one period may be changed.

Referring to FIG. 9 to FIG. 12, in the first control method of an embodiment, one control period may be controlled in a sequence (TP1→TP4→TP3→TP2) of the first time interval (TP1), the fourth time interval (TP4), the third time interval (TP3), and the second time interval (TP2), and a plurality of control periods may have different control sequences.

One control method may not have all of the first time interval (TP1) to the fourth time interval (TP4), and may have only some thereof. For example, in the first control method of the embodiment, one control period may be configured by a sequence of the first time interval (TP1), the second time interval (TP2), the third time interval (TP3), and the second time interval (TP2). As another example, in the first control method of the embodiment, one control period may be configured by a sequence of the first time interval (TP1), the fourth time interval (TP4), the third time interval (TP3), and the fourth time interval (TP4). The configuration of one control period may be different according to the magnitude of voltage (Vcf) of a floating capacitor. For example, if the voltage (Vcf) of the floating capacitor is lower than ½*Vo, in the first control method, one control period may not include a time interval—the fourth time interval (TP4)—in which the floating capacitor is discharged, or may include the time interval by configuring the time interval to have a smaller frequency or less time than a time interval—the second time interval (TP2)—in which the floating capacitor is charged. On the contrary, if the voltage (Vcf) of the floating capacitor is higher than ½*Vo, in the first control method of the embodiment, one control period may not include a time interval—the second time interval (TP2)—in which the floating capacitor is charged, or may include the time interval by configuring the time interval to have a smaller frequency or less time than a time interval—the fourth time interval (TP4)—in which the floating capacitor is discharged.

Referring to FIG. 13 to FIG. 16, in the second control method of an embodiment, one control period may be controlled in a sequence (TP3→TP2→TP1→TP4) of the third time interval (TP3), the second time interval (TP2), the first time interval (TP1), and the fourth time interval (TP4), and a plurality of control periods may have different control sequences.

One control period may not have all of the first time interval (TP1) to the fourth time interval (TP4) and may have only some thereof, wherein if the voltage (Vcf) of the floating capacitor is lower than ½*Vo, in the second control method of the embodiment, one control period may not include a time interval—the third time interval (TP3)—in which the floating capacitor is discharged, or may include the time interval by configuring the time interval to have a smaller frequency or less time than a time interval—the first time interval (TP1)—in which the floating capacitor is charged. On the contrary, if the voltage (Vcf) of the floating capacitor is higher than ½*Vo, in the second control method, one control period may not include a time interval—the first time interval (TP1)—in which the floating capacitor is charged, or may include the time interval by configuring the time interval to have a smaller frequency or less time than a time interval—the third time interval (TP3)—in which the floating capacitor is discharged.

In the first control method and the second control method in another embodiment, which are described with reference to FIG. 19 to FIG. 26, it is described that one control period is configured by a first time interval (TP1), a second time interval (TP2), a third time interval (TP3), and a fourth time interval (TP4), and a control sequence (TP1→TP2→TP3→TP4) from the first time interval (TP1) to the fourth time interval (TP4) is repeated in a plurality of control periods. However, in some cases, the configuration and control sequence of one period may be changed.

Referring to FIG. 19 to FIG. 22, in the first control method of another embodiment, one control period may be controlled in a sequence (TP1→TP4→TP3→TP2) of the first time interval (TP1), the fourth time interval (TP4), the third time interval (TP3), and the second time interval (TP2), and a plurality of control periods may have different control sequences.

One control period may not have all of the first time interval (TP1) to the fourth time interval (TP4) and may have only some thereof, wherein if the voltage (Vcf) of the floating capacitor is lower than ½*Vo, in the first control method of another embodiment, one control period may not include a time interval—the fourth time interval (TP4)—in which the floating capacitor is discharged, or may include the time interval by configuring the time interval to have a smaller frequency or less time than a time interval—the second time interval (TP2)—in which the floating capacitor is charged. On the contrary, if the voltage (Vcf) of the floating capacitor is higher than ½*Vo, in the first control method of another embodiment, one control period may not include a time interval—the second time interval (TP2)—in which the floating capacitor is charged, or may include the time interval by configuring the time interval to have a smaller frequency or less time than a time interval—the fourth time interval (TP4)—in which the floating capacitor is discharged.

Referring to FIG. 23 to FIG. 26, in the second control method of another embodiment, one control period may be controlled in a sequence (TP3→TP2→TP1→TP4) of the third time interval (TP3), the second time interval (TP2), the first time interval (TP1), and the fourth time interval (TP4), and a plurality of control periods may have different control sequences.

One control period may not have all of the first time interval (TP1) to the fourth time interval (TP4) and may have only some thereof, wherein if the voltage (Vcf) of the floating capacitor is lower than ½*Vo, in the second control method of another embodiment, one control period may not include a time interval—the third time interval (TP3)—in which the floating capacitor is discharged, or may include the time interval by configuring the time interval to have a smaller frequency or less time than a time interval—the first time interval (TP1)—in which the floating capacitor is charged. On the contrary, if the voltage (Vcf) of the floating capacitor is higher than ½*Vo, in the second control method, one control period may not include a time interval—the first time interval (TP1)—in which the floating capacitor is charged, or may include the time interval by configuring the time interval to have a smaller frequency or less time than a time interval—the third time interval (TP3)—in which the floating capacitor is discharged.

As described above, according to the embodiments, the charging/discharging balance of flying capacitors used in the step-up converter can be easily controlled.

Since terms, such as “including,” “comprising,” and “having” mean that corresponding elements may exist unless they are specifically described to the contrary, it shall be construed that other elements can be additionally included, rather than that such elements are omitted.

All technical, scientific or other terms are used consistently with the meanings as understood by a person skilled in the art unless defined to the contrary. Common terms as found in dictionaries should be interpreted in the context of the related technical writings, rather than overly ideally or impractically, unless the present disclosure expressly defines them so.

Although one embodiment of the present disclosure has been described for illustrative purposes, those skilled in the art will appreciate that various modifications, additions and substitutions are possible, without departing from the scope and spirit of the embodiment as disclosed in the accompanying claims. Therefore, the embodiments disclosed in the present disclosure are intended to illustrate the scope of the technical idea of the present disclosure, and the scope of the present disclosure is not limited by the embodiment. The scope of the present disclosure shall be construed on the basis of the accompanying claims in such a manner that all of the technical ideas included within the scope equivalent to the claims belong to the present disclosure.

What is claimed is:

1. A step-up converter comprising:
an inductor unit configured to receive an input voltage in one side thereof and include an inductor;
a power switch unit including a plurality of serially connected power switches to control power path, and including a flying capacitor connected in parallel to at least two power switches among the plurality of power switches, wherein one node between the at least two power switches is connected to another side of the inductor unit;
an auxiliary capacitor connected to the one node via an auxiliary switch; and
a control unit configured to:
control the power switch unit to convert the input voltage into an output voltage; and
allow the flying capacitor and the auxiliary capacitor to be connected in parallel in one time interval and allow the flying capacitor and the auxiliary capacitor to be connected in series in another time interval, in each control period.

2. The step-up converter of claim 1, wherein the control unit controls the power switch unit so that voltage of the one node changes four times or more in each control period.

3. The step-up converter of claim 1, wherein the flying capacitor is charged in the one time interval, and the flying capacitor is discharged in the another time interval.

4. The step-up converter of claim 1, wherein the flying capacitor and the auxiliary capacitor are connected in parallel to an output capacitor, in which the output voltage is generated, in the another time interval.

5. The step-up converter of claim 1, wherein a ground voltage and the output voltage are generated at both ends of the power switch unit, a flying capacitor voltage is generated in the flying capacitor, and the control unit controls the power switch unit so that the ground voltage is generated in the one node in a first time interval, a voltage of a level obtained by adding the flying capacitor voltage to the ground voltage is generated in the one node in a second time interval, the ground voltage is generated in the one node in a third time interval, and a voltage of a level obtained by subtracting the flying capacitor voltage from the output voltage is generated in the one node in a fourth time interval.

6. The step-up converter of claim 5, wherein the control unit turns off the auxiliary switch in the first time interval and the third time interval, and turns on the auxiliary switch in the second time interval and the fourth time interval so as to allow the auxiliary capacitor to be connected to the one node.

7. The step-up converter of claim 1, wherein a ground voltage and the output voltage are generated at both ends of the power switch unit, a flying capacitor voltage is generated in the flying capacitor, and the control unit controls the power switch unit so that a voltage of a level obtained by adding the flying capacitor voltage to the ground voltage is generated in the one node in a first time interval, the output voltage is generated in the one node in a second time interval, a voltage of a level obtained by subtracting the flying capacitor voltage from the output voltage is generated in the one node in a third time interval, and the output voltage is generated in the one node in a fourth time interval.

8. The step-up converter of claim 7, wherein the control unit turns on the auxiliary switch to connect the auxiliary capacitor to the one node in the first time interval and the third time interval, and turns off the auxiliary switch in the second time interval and the fourth time interval.

9. A step-up converter comprising:
an inductor unit configured to receive an input voltage in one side thereof and include an inductor;
a power switch unit including a plurality of serially connected power switches to control power path, and including a flying capacitor connected in parallel to at least two power switches among the plurality of power switches, wherein one node between the at least two power switches is connected to another side of the inductor unit;
an auxiliary capacitor connected to the flying capacitor via two auxiliary switches connected to both ends of the flying capacitor, respectively; and
a control unit configured to:
control the power switch unit to convert the input voltage into an output voltage; and
allow the flying capacitor and the auxiliary capacitor to be connected in parallel in one time interval and allow the flying capacitor and the auxiliary capacitor to be connected in series in another time interval, in each control period.

10. The step-up converter of claim 9, wherein the control unit controls the power switch unit so that voltage of the one node changes four times or more in each control period.

11. The step-up converter of claim 9, wherein the flying capacitor and the auxiliary capacitor are connected in parallel to an output capacitor, in which the output voltage is generated, in the another time interval.

12. The step-up converter of claim 9, wherein a ground voltage and the output voltage are generated at both ends of the power switch unit, a flying capacitor voltage is generated in the flying capacitor, and the control unit controls the power switch unit so that the ground voltage is generated in the one node in a first time interval, a voltage of a level obtained by adding the flying capacitor voltage to the ground voltage is generated in the one node in a second time interval, the ground voltage is generated in the one node in a third time interval, and a voltage of a level obtained by subtracting the flying capacitor voltage from the output voltage is generated in the one node in a fourth time interval.

13. The step-up converter of claim 12, wherein the control unit: turns off a first auxiliary switch and a second auxiliary switch in the first time interval and the third time interval; and turns on the first auxiliary switch connected to a positive terminal of the flying capacitor and turns off the second auxiliary switch so as to allow the auxiliary capacitor to be connected to the positive terminal of the flying capacitor, in the second time interval; and turns on the second auxiliary switch connected to a negative terminal of the flying capacitor and turns off the first auxiliary switch so as to allow the auxiliary capacitor to be connected to the negative terminal of the flying capacitor, in the fourth time interval.

14. The step-up converter of claim 9, wherein a ground voltage and the output voltage are generated at both ends of the power switch unit, a flying capacitor voltage is generated in the flying capacitor, and the control unit controls the power switch unit so that a voltage of a level obtained by adding the flying capacitor voltage to the ground voltage is generated in the one node in a first time interval, the output voltage is generated in the one node in a second time interval, a voltage of a level obtained by subtracting the flying capacitor voltage from the output voltage is generated in the one node in a third time interval, and the output voltage is generated in the one node in a fourth time interval.

15. The step-up converter of claim 14, wherein the control unit: turns off a first auxiliary switch and a second auxiliary switch in the second time interval and the fourth time interval; turns on the first auxiliary switch connected to a positive terminal of the flying capacitor, and turns off the second auxiliary switch so as to allow the auxiliary capacitor to be connected the positive terminal of the flying capacitor, in the first time interval; and turns on the second auxiliary switch connected to a negative terminal of the flying capacitor, and turns off the first auxiliary switch so as to allow the auxiliary capacitor to be connected to the negative terminal of the flying capacitor, in the third time interval.
